(19) United States
(12) Patent Application Publication
(10) Pub. No.: US 2004/0159194 A1
(43) Pub. Date: Aug. 19, 2004

(54) Joint of channel-lock pliers

(76) Inventor: Cheng-Cheng Ting, Tali City (TW)

Correspondence Address: Jackson Walker L.L.P., Suite 2100, 112 E. Pecan Street, San Antonio, TX, 78205, US

(21) Appl. No.: 10/369,234

(22) Filed: Feb. 19, 2003

(51) Int. Cl. B25B 7/06

(52) U.S. Cl. 81/416

(57) ABSTRACT

A joint of a pair of channel-lock pliers having an adjustable handle and a reference handle that are pivotally connected at a junction includes an elongated hole defined through the reference handle at the junction, a joint hole defined through the adjustable handle at the junction corresponding to the elongated hole and a pivot pin pivotally connecting the adjustable and the reference handles at the junction. The pivot pin has an enlarged first end and a second end, which passes through the elongated hole and the countersunk pivot hole in the handles and extends out of the countersunk pivot hole in the adjustable handle to be pressed and spread to pivotally rivet the handles together and be ground smooth to prevent protruding from the adjustable handle. Consequently, the handles are joined firmly, and appearance of the pliers is nice.

### BACKGROUND OF THE INVENTION

1. Field of the Invention

The present invention relates to a joint of a pair of channel-lock pliers, and more particularly to a simple joint of a pair of channel-lock pliers, which operates smoothly.

2. Description of Related Art

Channel-lock pliers, also called groove joint pliers, are used to grip pipes in plumbing. With reference to FIG. 4, a pair of channel-lock pliers (not numbered) comprises an adjustable handle (30), a reference handle (40) and a conventional joint (not numbered). The adjustable and the reference handles (30, 40) are pivotally connected to each other with the conventional joint at a junction (not numbered). A toothed jaw (41) is formed near the conventional joint on both handles (30, 40). The conventional joint comprises an elongated hole (51), a joint hole (not shown), a bolt (52) and a nut (53). The elongated hole (51) is transversally defined through the reference handle (40) near the toothed jaw (41). The joint hole is defined through the adjustable handle (30) corresponding to the elongated hole (51) in the reference handle (40). The bolt (52) has an enlarged head (521), a shank (522) and a treaded end (not numbered). The treaded end of the bolt (52) passes through the elongated hole (51) and the joint hole and extends out of the joint hole, and the nut (53) is screwed onto the threaded end. Thereafter, the two handles (30, 40) are pivotally joined at the junction to form the channel-lock pliers.

However, such a conventional joint of a pair of channel-lock pliers has the following shortcomings.

First, the nut (53) screwed onto the threaded end of the bolt (52) inadvertently loosens. The handles (30, 40) of the channel-lock pliers are repeatedly squeezed and released. After extensive use, squeezing or releasing operation of the handles (30, 40) can inadvertently loosening the nut (53). Finally, the handles (30, 40) of the channel-lock pliers will come apart and cannot be used unless the nut (53) is screwed onto the bolt (52) again.

Second, the nut (53) protrudes from the adjustable handle (30), is unsightly, may injure a person using the pliers or damage equipment on which the pliers are used.

To overcome the shortcomings, the present invention provides a joint for a pair of channel-lock pliers to mitigate or obviate the aforementioned problems.

### SUMMARY OF THE INVENTION

The main objective of the invention is to provide a joint for a pair of channel-lock pliers, which can firmly hold the handles of the pliers together.

Another objective of the invention is to provide a joint for a pair of channel-lock pliers such that the pliers have a nice appearance.

Other objectives advantages and novel features of the invention will become more apparent from the following detailed description when taken in conjunction with the accompanying drawings.

### BRIEF DESCRIPTION OF THE DRAWINGS

FIG. 1 is an enlarged, exploded perspective view of a joint in accordance with the present invention for a pair of channel-lock pliers;

FIG. 2 is a perspective view of the channel-lock pliers in FIG. 1;

FIG. 3 is a cross sectional side plan view of the joint depicting the assembly process of joint; and

FIG. 4 is a perspective view of a pair of channel-lock pliers with a conventional joint in accordance with the prior art.

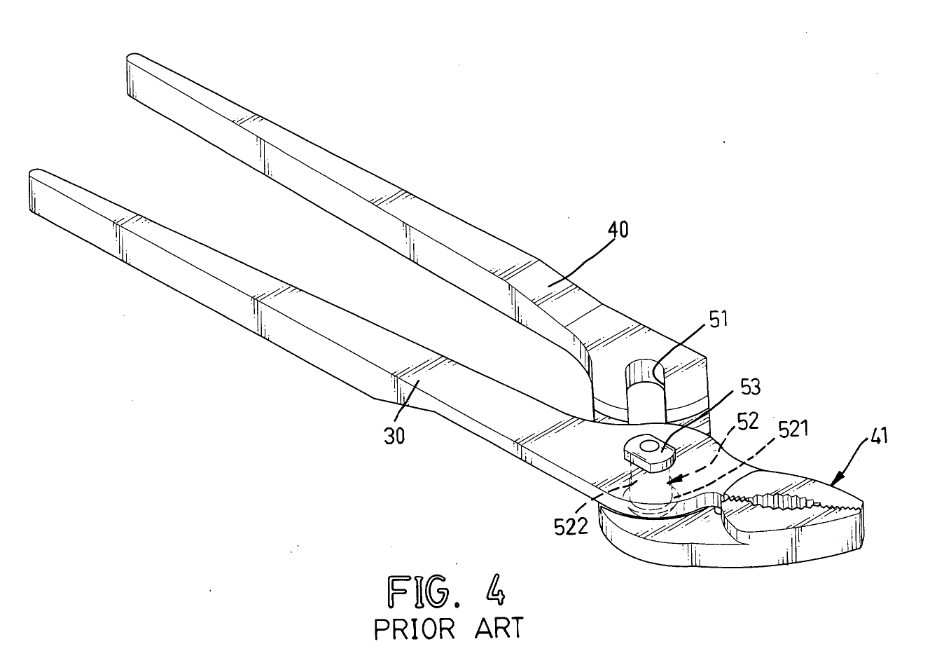

### DETAILED DESCRIPTION OF PREFERRED EMBODIMENT

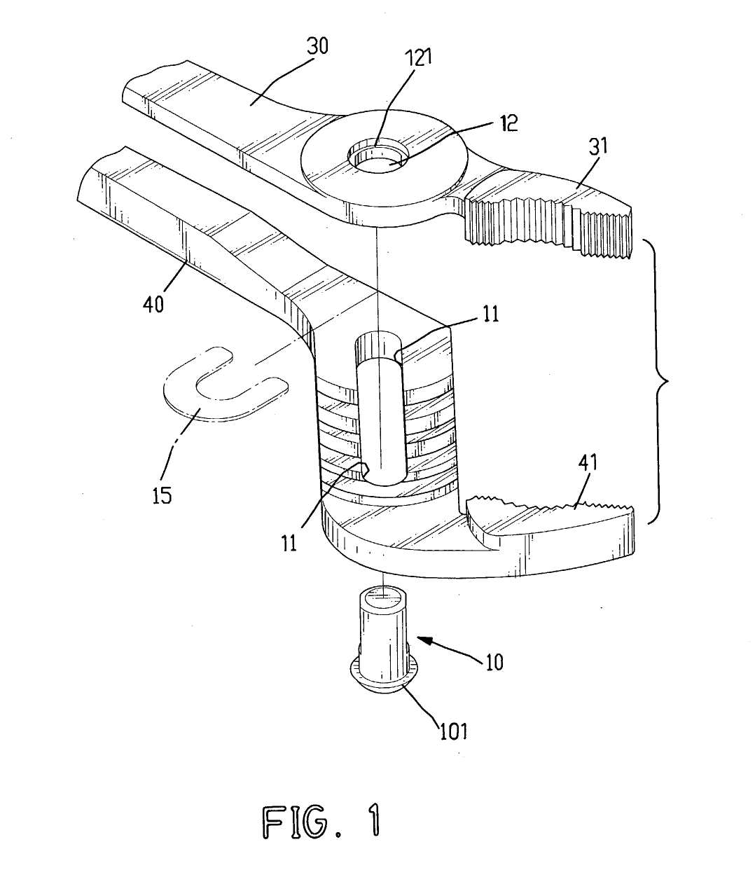

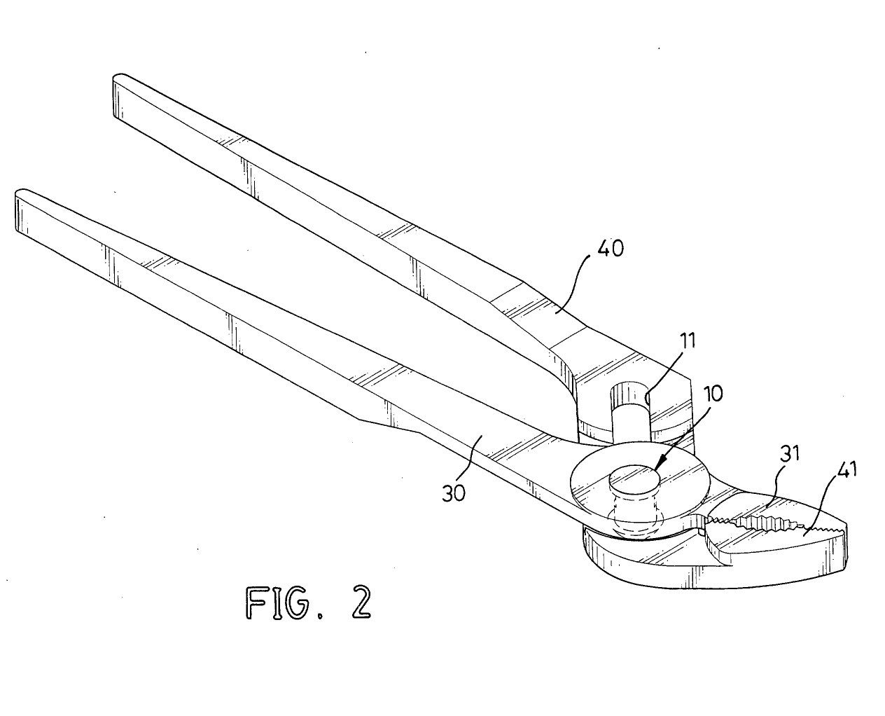

With reference to FIGS. 1 and 2, a pair of channel-lock pliers (not numbered) has an adjustable handle (30) and a reference handle (40). The adjustable and the reference handles (30, 40) are pivotally connected by a joint (not numbered) in accordance with the present invention at a junction (not numbered). The adjustable handle (30) has a first toothed jaw (31) extending from the junction of the pliers. Similar, the reference handle (40) has a second toothed jaw (41) corresponding to the first toothed jaw (31).

The adjustable handle (30) and the reference handle (40) have an inside surface (not numbered) that faces the opposite handle and an outside surface (not numbered). The joint comprises a pivot pin (10), an elongated hole (11) and a countersunk pivot hole (12). The pivot pin (10) has a keyed shank (not numbered), a first end (not numbered) and a second end (not numbered). An enlarged head (101) is formed at the first end of the pivot pin (10). The elongated hole (11) is defined through the reference handle (40) at the junction of the pliers. The countersunk pivot hole (12) is defined through the adjustable handle (30) at the junction of the pliers and corresponds to the elongated hole (11). The countersunk pivot hole (12) has an inner surface (not numbered), is keyed and corresponds to the keyed shank of the pivot pin (10). An annular shoulder (121) is formed on the inner surface of the countersunk pivot hole (12) on the outside surface of the adjustable handle (30).

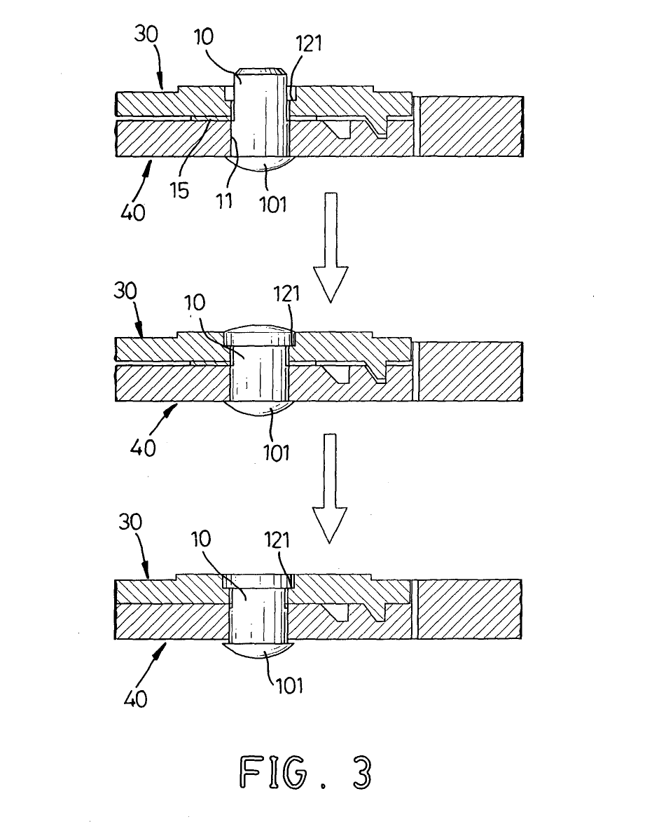

With reference to FIG. 3, the second end of the pivot pin (10) passes through the elongated hole (11) in the reference handle (40) and the countersunk pivot hole (12) in the adjustable handle (30). A washer (15) is mounted between the two handles (30, 40) corresponding to the pivot pin (10). The washer (15) could be U-shaped, C-shaped or the like. The second end of the pivot pin (10) extends out of the joint hole (12) in the adjustable handle (30). The second end of the pivot pin (10) is pressed and spread to pivotally rivet the two handles (30, 40) together. The spread second end of the pivot pin (10) is received in the countersunk pivot hole (12) and is enlarged to engage the shoulder (121) in the countersunk pivot hole (12). The pressed second end of the pivot pin (10) is ground down flush with the outside surface of the adjustable handle (30). The washer (15) is removed to allow the two handles (30, 40) to be pivotally squeezed.

The joint provides a stable joint for the pliers. The enlarged second end of the pivot pin (10) barely disengages from the shoulder (121), but the pivot pin (10) firmly holds the two handles (30, 40) together. Even after extensive use, the joint will still be stable, and the two handles (30, 40) will not easily come apart. Furthermore, the appearance of second end of the pivot pin (10) of the joint is smooth. The smoothed second end of the pivot pin (10) prevents any protrusion from the outside surface of the adjustable handle (30). Appearance of the pliers is nice and the pliers will be nice looking.

Other features or structures of the channel-lock pliers are conventional, a description of the conventional features of the pliers is not provided.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A joint of a pair of channel-lock pliers having a reference handle with an outside surface and an inside surface, an adjustment handle with an outside surface and an inside surface pivotally connected to the reference handle at a junction where the inside surfaces face each other, and the joint comprising:
an elongated hole adapted to be defined through the reference handle at the junction of the handles;
a countersunk pivot hole adapted to be defined through the adjustable handle at the junction of the handles and corresponding to the elongated hole, the countersunk pivot hole having an inner surface and being keyed, and an annular shoulder formed on the inner surface of the countersunk pivot hole; and
a pivot pin adapted to pivotally connect the adjustable handle to the reference handle at the junction and the pivot pin having
a first end,
an enlarged head formed at the first end of the pivot pin,
a keyed shank corresponding to the keyed countersunk pivot hole, and
a second end passing through the elongated hole and the countersunk pivot hole and extending out of the countersunk pivot hole;
where the second end of the pivot pin is adapted to be pressed, spread and ground smooth with the outside surface of the adjustable handle so that the spread second end of the pivot pin is larger than the keyed countersunk pivot hole, whereby the spread second end of the pivot pin engages the shoulder in the countersunk pivot hole to firmly hold the adjustable and the reference handles together and does not protrude out of the countersunk pivot hole in the adjustable handle.
